(19) United States
(12) Patent Application Publication
(10) Pub. No.: US 2023/0267460 A1
(43) Pub. Date: Aug. 24, 2023

(54) MULTI-USER, SHARED BLOCKCHAIN SYSTEM

(71) Applicants: John Scannell, Cortland, OH (US); William Landers, Auburn, IL (US)

(72) Inventors: John Scannell, Cortland, OH (US); William Landers, Auburn, IL (US)

(21) Appl. No.: 18/106,627

(22) Filed: Feb. 7, 2023

Related U.S. Application Data
(60) Provisional application No. 63/267,659, filed on Feb. 7, 2022.
(60) Provisional application No. 63/267,656, filed on Feb. 7, 2022.
(60) Provisional application No. 63/346,620, filed on May 27, 2022.

(51) Int. Cl. G06Q 20/38; G06Q 20/32; G06K 7/14

(52) U.S. Cl. CPC G06Q 20/389; G06Q 20/3276; G06K 7/1417

(57) ABSTRACT

Embodiments provide a system where a user can obtain a fractional portion of a blockchain unit. The fractional portion can be obtained as part of a separate arrangement. A computer ledger tracks the fractional interests of multiple users. An aggregator computer communicates with a blockchain computer to record ownership of one or more whole units in a pool. In one embodiment, a concierge system is provided that supports a social equity economy.

### RELATED APPLICATIONS

This application relates to, and claims priority from, provisional application No. 63/346,620, filed May 27, 2022, provisional application No. 63/267,659 filed Feb. 7, 2022, and provisional application No. 63/267,656 filed Feb. 7, 2022.

### BACKGROUND OF THE INVENTION

This application relates to blockchain systems, and in particular to a system providing for multiple users to share in a single unit or NFT of a blockchain.

It would be desirable for users to participate in blockchain units without the need to own the unit and without being restricted to a particular type of blockchain unit.

Unless otherwise indicated herein, the materials described in this section of the Specification are not prior art to the claims in this application and are not admitted to be prior art by inclusion in this section.

### BRIEF SUMMARY OF THE INVENTION

Embodiments provide a system where a user can obtain a fractional portion of a blockchain unit. The fractional portion can be obtained as part of a separate arrangement. A computer ledger tracks the fractional interests of multiple users. An aggregator computer communicates with a blockchain computer to record ownership of one or more whole units in a pool.

In one embodiment, the worth of the whole units is tracked, and is reflected in the computer ledger and a corresponding user ledger application. A current fractional worth is determined when a user desires to withdraw from the pool.

In one embodiment, a wireless reader is provided. The reader can read or scan one or more of and RFID code, QR code, bar code, NFC, Bluetooth® communication, or other wireless information technology. A projected or holographic display is provided in response to the scanned or read information.

In one embodiment, the reader obtains a scanned code corresponding to a loyalty award, and an image provides information to the user regarding the size of the award. In addition, the award information is transmitted to a ledger application on a user device.

In one embodiment, a concierge system is provided that supports a social equity economy. A users or influencer can deposit their time value, task value, or posts to social media in exchange for value out of a tokenized project, so they can bill against their time or task or online posts for fractional shares and then redeem them for a selected currency at the deemed exchange rates. The system holds multiple types of value (e.g., multiple blockchain NFTs, crypto, etc.) and allows the back-end to invest in the best assets outside of that what the app users are requesting. This will create an internal economy where some users give their time and other users give their services, all with intent or goal of building the intended project they want value in.

This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim.

The foregoing, together with other features and examples, will be described in more detail below in the following specification, claims, and accompanying drawings.

The terms and expressions that have been employed are used as terms of description and not of limitation, and there is no intention in the use of such terms and expressions of excluding any equivalents of the features shown and described or portions thereof. It is recognized, however, that various modifications are possible within the scope of the systems and methods claimed. Thus, although the present system and methods have been specifically disclosed by examples and optional features, modification and variation of the concepts herein disclosed should be recognized by those skilled in the art, and that such modifications and variations are considered to be within the scope of the systems and methods as defined by the appended claims.

### BRIEF DESCRIPTION OF THE DRAWINGS

The features of the various embodiments described above, as well as other features and advantages of certain embodiments of the present invention will be more apparent from the following detailed description taken in conjunction with the accompanying drawings, in which:

FIG. 1 is a diagram of a multi-user, shared, blockchain system according to embodiments;

FIG. 2 is a diagram of a reader device with projection, according to embodiments;

FIG. 3 is a diagram of a user reader device with projection and other elements, according to embodiments;

FIG. 4 is a flow diagram illustrating the flow of operation of the multi-user, shared blockchain system of FIG. 1, according to embodiments; and

FIG. 5 is a simplified block diagram of a representative computing system and client computing system usable to implement certain embodiments of the present invention.

FIG. 6 is a diagram illustrating the interface with a user, according to certain embodiments.

FIG. 7 is a diagram illustrating a concierge system, according to certain embodiments.

### DETAILED DESCRIPTION OF THE INVENTION

### Overall Architecture

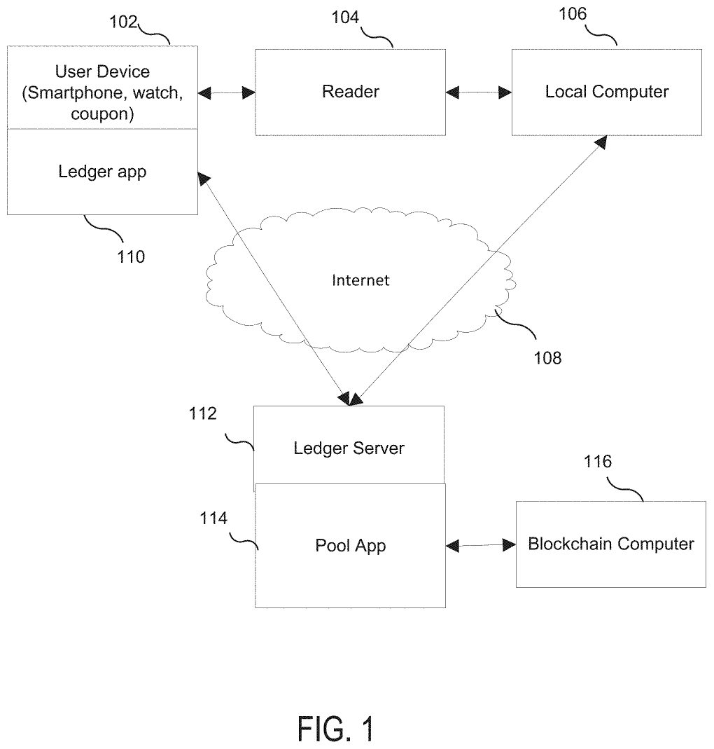

FIG. 1 is a diagram of a multi-user, shared, blockchain system according to embodiments. A user device 102 has a code that is read by a reader 104. The user device can be a smartphone, a smart watch, a paper coupon, a product with an embedded RFID tag, a card, or any other user device. The reader 104 can be at a retailer or as part of any kiosk or computer, including a home computer. A local computer 106 can be a host computer of a business, a home computer, an internet server, or any other computing device. The reader can read or scan one or more of an RFID code, mag stripe, QR code, bar code, NFC, Bluetooth® communication, or other wireless information technology.

Reader 104 can read a code corresponding to a loyalty incentive, or can simply read another arrangement (e.g., transaction) with an associated loyalty incentive being provided by software on the reader, local computer, or elsewhere. Alternately, an agreed amount for another arrangement can be rounded up to provide a loyalty award. The reader can also receive a user ID from the user device, such as a user name, a device ID, a card number, etc.

In one embodiment, the amount of an award is transmitted through the internet 108, or a local or wide area network or other communication means, to a Ledger computer or server 112. The ledger server maintains a table indicating the amount of awards corresponding to a user ID. This amount is also transmitted to a user application ledger 110 across the internet 108 or other communication network or means.

In one embodiment, ledger server 112 maintains a pool application 114. The pool application logs the award amounts for each one of multiple users. The total amounts can be aggregated and communicated to a blockchain computer to register ownership of units in a blockchain. Each individual user may thus have a fractional amount of a blockchain unit. The blockchain unit can be a crypto currency, an NFT (Non-Fungible Token), or any other digital asset. Each user can have a fractional interest in the pool, which can contain multiple blockchain units of different types. For example, the user can have a fractional share of multiple crypto currencies or multiple NFTs. The value can fluctuate over time, and the user can exit the pool and receive a redeemable credit in the amount of the current value of the user's fractional share.

In one embodiment, ledger server 112 maintains a list of fractional interests of multiple users, and accumulates those interests until there is enough for a whole unit in the blockchain. Thus, fractional interests are periodically batched to allow the acquisition of additional units.

In one embodiment, ledger server 112 updates a user's ledger app 110 with information about a user's current fractional holdings of the different blockchain units, and a current valuation of the user's fractional shares. The user's ledger application (e.g., a wallet app), can provide for transferring or acquiring fractional interests. The fractional interest can be applied to a new arrangement (e.g., purchase transaction) in one embodiment.

### Randomized Holographic Loyalty Display Generator

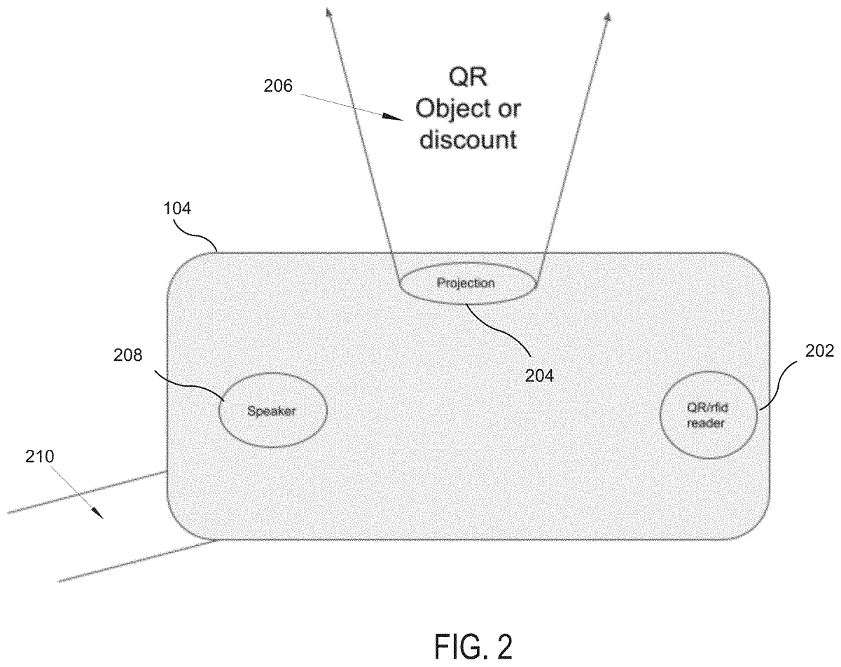

FIG. 2 is a diagram of a reader device with projection, according to embodiments. Reader device 104 includes a scanner 202 or other electronic reader for reading one or more of and RFID code, QR code, bar code, NFC, Bluetooth® communication, or other wireless information technology. Scanned information can then be used to project information with a projector 204 into a holographic projection area 206 or onto a screen using a non-holographic projector. Additionally, information can be provided through a speaker 208. The reader device us supported on an arm 210. The information can be derived directly from the scanned or read information, or the scanned or read information can be used to index into a look-up table or other mechanism to determine what information, images, etc. should be projected and corresponding audio should be provided to speaker 208. In one embodiment, a still image or video could be projected. The projection images or video can include LIDAR or radar or camera photographs (in the real world or a metaverse) of dispensaries, restaurants, and other business that provide or redeem loyalty awards.

In embodiments, the reader is able to scan RFID, QR, or other information technology (which can be encrypted) that cause projection of specific or randomized products in a 3D image. In embodiments, a mobile device cameras can capture an image of the projection. The projection can even include a new bar code, QR code, etc, linked to additional information for the user, which can be retrieved through an app on the user device. For example, the information read can be used to integrate into an technology application platform, discount or other sales platform to enhance to a retail or personal experiences.

In embodiments, the reader can be used for retail displays displaying a randomized lottery type prize or display upon using the discount or RFID scanning technology. Applications also extend to personal consumption where projection devices can be integrated into personal objects such as phone cases, rolling trays, speaker systems, laptops etc.

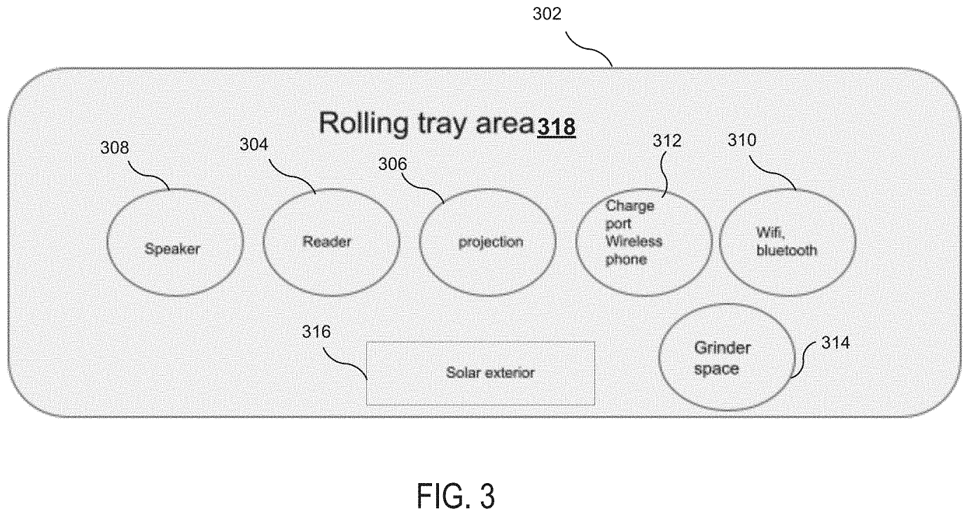

FIG. 3 is a diagram of a user reader device with projection and other elements, according to embodiments. User reader device 302 can be shaped as a tray, with a rolling tray area 318. Included are a reader 304 for a QR code, bar code, etc. Reader 304 can be located in the bottom of the tray, in an elevated area next to a rolling are 318 on the tray, or on a side of the tray, or any other location. The other elements shown likewise can be provided in a variety of locations. A projector device 306 is provided, along with a speaker 308. In addition, a separate wireless transceiver 310 is provided, for one or more of WiFi, Bluetooth® communication, etc. A charge port 312 is also provided for a users phone or other device. The charge port can be a wire connection or an inductive interface. The user device can be powered with an electrical wire connection, a battery, and/or a solar panel 316 that covers at least some of the exterior of reader 302.

In embodiments, this system all integrates into a software application that allows for QR codes and RFID readers to scan the marketing materials of discounts or other products to create a randomized lottery discount inside grocery stores, retail, convenience stores and dispensaries as well as personal settings, to have life-like images displayed upon scanning to determine the contents of the scannable object. These can be utilized in any retail outlet or personal use object where offers, music, and other electronic data can be stored on RFID, QR, or other transportable objects.

In embodiments, this device includes life-like 3D projections using light projection, speakers, charging ports (personal use), solar trickle charging to extend battery life, wife, and Bluetooth® wireless systems, and has space for tools such as grinder space 314 or rolling papers and lighters (personal use). The grinder space can be a receptacle for holding a grinder, or can be an integrated grinder.

### Flow Diagram for Example Embodiment

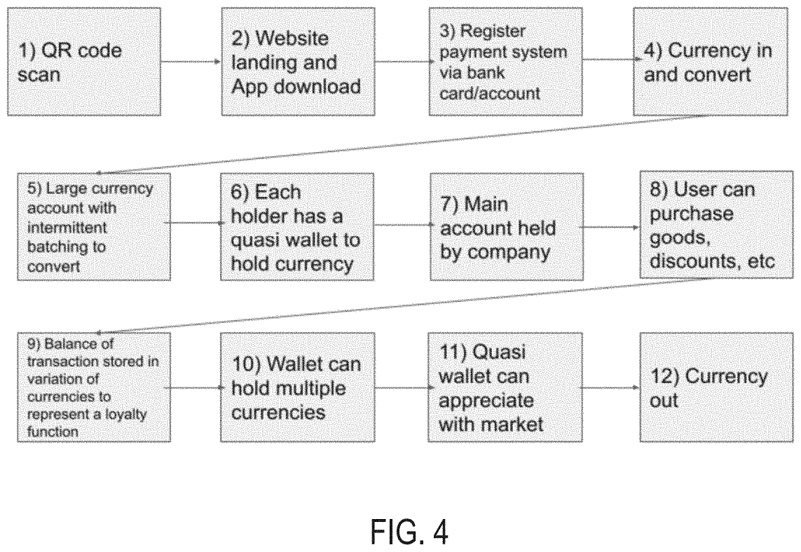

FIG. 4 is a flow diagram illustrating the flow of operation of the multi-user, shared blockchain system of FIG. 1, according to embodiments.
1) User can interact with platform via QR codes or traditional advertising discover.
2) Traffic driven to a website or app platform.
3) Users register the payment system via bank account or any other payment system.
4) Users convert currency into other currencies.
5) There is a large currency account that batches all the crypto currencies.
6) Each user has a wallet that represents their share of the currency without actually owning it.
7) There is a main account held by the company that holds a portfolio of investments that allow the currency users select to be invested in.
8) User can purchase any good from the platform and use their source wallet of any currency available.
9) Balance of transaction stored in currencies of various types of hedge against market fluctuations, these are loyalty aspects of the app that encourage the use to keep interacting to have small investments something that would costs a lot of transaction fees to accomplish, but when done in mass, brings the fees down and encourages anyone to invest with a concierge service to encourage and guide investments.
10) The wallet can hold any currency of choice or one specific currency.
11) Appreciations or deprecations are reflect over time with the market, and encourages users to keep their loyalty in the account to encourage reinvesting over time.
12) Users can pull currency out any time and realize a gain and we report the transaction through to tax agency and file tax returns to protect customers and make process as seamless as possible to invest in new currencies.

### Computer Systems for Media Platform and Client System

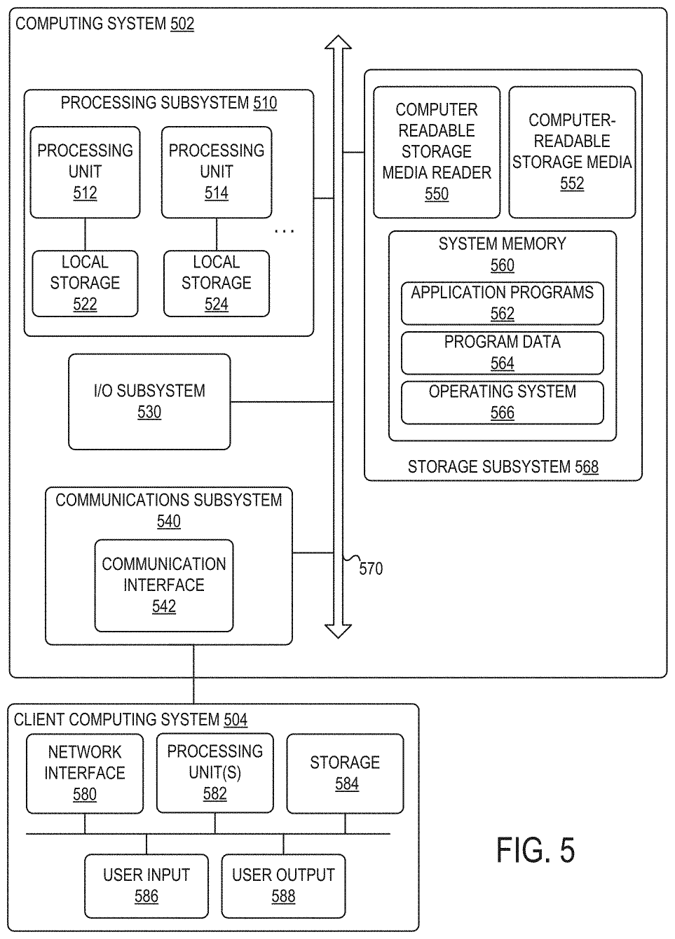

Various operations described herein may be implemented on computer systems. FIG. 5 shows a simplified block diagram of a representative computing system 502 and client computing system 504 usable to implement certain embodiments of the present invention. For example, ledger server 112 could be the computing system 502, and local computer 106 could be the client computing system 504. In various embodiments, computing systems 502 or 504 or similar systems may implement the blockchain computer, user device, or any other computing system described herein or portions thereof. Client computing system 504 or similar systems may implement user devices such as a smartphone or watch with a ledger application.

Computing system 502 may be one of various types, including processor and memory, a handheld portable device (e.g., an iPhone® cellular phone, an iPad® computing tablet, a PDA), a wearable device (e.g., a Google Glass® head mounted display), a personal computer, a workstation, a mainframe, a kiosk, a server rack, or any other data processing system.

Computing system 502 may include processing subsystem 510. Processing subsystem 510 may communicate with a number of peripheral systems via bus subsystem 570. These peripheral systems may include I/O subsystem 530, storage subsystem 568, and communications sub system 540.

Bus subsystem 570 provides a mechanism for letting the various components and subsystems of server computing system 504 communicate with each other as intended. Although bus subsystem 570 is shown schematically as a single bus, alternative embodiments of the bus subsystem may utilize multiple buses. Bus subsystem 570 may form a local area network that supports communication in processing subsystem 510 and other components of server computing system 502. Bus subsystem 570 may be implemented using various technologies including server racks, hubs, routers, etc. Bus subsystem 570 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which may be implemented as a Mezzanine bus manufactured to the IEEE P1386.1 standard, and the like.

I/O subsystem 530 may include devices and mechanisms for inputting information to computing system 502 and/or for outputting information from or via computing system 502. In general, use of the term “input device” is intended to include all possible types of devices and mechanisms for inputting information to computing system 502. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computing system 502 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Processing subsystem 510 controls the operation of computing system 502 and may comprise one or more processing units 512, 514, etc. A processing unit may include one or more processors, including single core processor or multicore processors, one or more cores of processors, or combinations thereof. In some embodiments, processing subsystem 510 may include one or more special purpose co-processors such as graphics processors, digital signal processors (DSPs), or the like. In some embodiments, some or all of the processing units of processing subsystem 510 may be implemented using customized circuits, such as application specific integrated circuits (ASICs), or field programmable gate arrays (FPGAs). In some embodiments, such integrated circuits execute instructions that are stored on the circuit itself. In other embodiments, processing unit(s) may execute instructions stored in local storage, e.g., local storage 522, 524. Any type of processors in any combination may be included in processing unit(s) 512, 514.

In some embodiments, processing subsystem 510 may be implemented in a modular design that incorporates any number of modules (e.g., blades in a blade server implementation). Each module may include processing unit(s) and local storage. For example, processing subsystem 510 may include processing unit 512 and corresponding local storage 522, and processing unit 514 and corresponding local storage 524.

Local storage 522, 524 may include volatile storage media (e.g., conventional DRAM, SRAM, SDRAM, or the like) and/or non-volatile storage media (e.g., magnetic or optical disk, flash memory, or the like). Storage media incorporated in local storage 522, 524 may be fixed, removable or upgradeable as desired. Local storage 522, 524 may be physically or logically divided into various subunits such as a system memory, a ROM, and a permanent storage device. The system memory may be a read-and-write memory device or a volatile read-and-write memory, such as dynamic random access memory. The system memory may store some or all of the instructions and data that processing unit(s) 512, 514 need at runtime. The ROM may store static data and instructions that are needed by processing unit(s) 512, 514. For example, the pool application 114 and its data could be stored in such storage devices. The permanent storage device may be a non-volatile read-and-write memory device that may store instructions and data even when a module including one or more processing units 512, 514 and local storage 522, 524 is powered down. The term “storage medium” as used herein includes any medium in which data may be stored indefinitely (subject to overwriting, electrical disturbance, power loss, or the like) and does not include carrier waves and transitory electronic signals propagating wirelessly or over wired connections.

In some embodiments, local storage 522, 524 may store one or more software programs to be executed by processing unit(s) 512, 514, such as an operating system and/or programs implementing various server functions such as functions of UPP system 102, or any other server(s) associated with UPP system 102. “Software” refers generally to sequences of instructions that, when executed by processing unit(s) 512, 514 cause computing system 502 (or portions thereof) to perform various operations, thus defining one or more specific machine implementations that execute and perform the operations of the software programs. The instructions may be stored as firmware residing in read-only memory and/or program code stored in non-volatile storage media that may be read into volatile working memory for execution by processing unit(s) 512, 514. In some embodiments the instructions may be stored by storage subsystem 568 (e.g., computer readable storage media). In various embodiments, the processing units may execute a variety of programs or code instructions and may maintain multiple concurrently executing programs or processes. At any given time, some or all of the program code to be executed may be resident in local storage 522, 524 and/or in storage subsystem including potentially on one or more storage devices. Software may be implemented as a single program or a collection of separate programs or program modules that interact as desired. From local storage 522, 524 (or non-local storage described below), processing unit(s) 512, 514 may retrieve program instructions to execute and data to process in order to execute various operations described above.

Storage subsystem 568 provides a repository or data store for storing information that is used by computing system 502. Storage subsystem 568 provides a tangible non-transitory computer-readable storage medium for storing the basic programming and data constructs that provide the functionality of some embodiments. Software (programs, code modules, instructions) that when executed by processing subsystem 510 provide the functionality described above may be stored in storage subsystem 568. The software may be executed by one or more processing units of processing subsystem 510. Storage subsystem 568 may also provide a repository for storing data used in accordance with the present invention.

Storage subsystem 568 may include one or more non-transitory memory devices, including volatile and non-volatile memory devices. As shown in FIG. 5, storage subsystem 568 includes a system memory 560 and a computer-readable storage media 552. System memory 560 may include a number of memories including a volatile main RAM for storage of instructions and data during program execution and a non-volatile ROM or flash memory in which fixed instructions are stored. In some implementations, a basic input/output system (BIOS), containing the basic routines that help to transfer information between elements within computing system 502, such as during start-up, may typically be stored in the ROM. The RAM typically contains data and/or program modules that are presently being operated and executed by processing subsystem 510. In some implementations, system memory 560 may include multiple different types of memory, such as static random access memory (SRAM) or dynamic random access memory (DRAM). Storage subsystem 568 may be based on magnetic, optical, semiconductor, or other data storage media. Direct attached storage, storage area networks, network-attached storage, and the like may be used. Any data stores or other collections of data described herein as being produced, consumed, or maintained by a service or server may be stored in storage subsystem 568.

By way of example, and not limitation, as depicted in FIG. 5, system memory 560 may store application programs 562, which may include client applications, Web browsers, mid-tier applications, relational database management systems (RDBMS), etc., program data 564, and one or more operating systems 566. By way of example, an example operating systems may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Computer-readable storage media 552 may store programming and data constructs that provide the functionality of some embodiments. Software (programs, code modules, instructions) that when executed by processing subsystem 510 a processor provide the functionality described above may be stored in storage subsystem 568. By way of example, computer-readable storage media 552 may include non-volatile memory such as a hard disk drive, a magnetic disk drive, an optical disk drive such as a CD ROM, DVD, a Blu-Ray® disk, or other optical media. Computer-readable storage media 552 may include, but is not limited to, Zip® drives, flash memory cards, universal serial bus (USB) flash drives, secure digital (SD) cards, DVD disks, digital video tape, and the like. Computer-readable storage media 552 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. Computer-readable media 552 may provide storage of computer-readable instructions, data structures, program modules, and other data for computing system 502.

In certain embodiments, storage subsystem 568 may also include a computer-readable storage media reader 550 that may further be connected to computer-readable storage media 552. Together and, optionally, in combination with system memory 560, computer-readable storage media 552 may comprehensively represent remote, local, fixed, and/or removable storage devices plus storage media for storing computer-readable information.

In certain embodiments, computing system 502 may provide support for executing one or more virtual machines. Computing system 502 may execute a program such as a hypervisor for facilitating the configuring and managing of the virtual machines. Each virtual machine may be allocated memory, compute (e.g., processors, cores), I/O, and networking resources. Each virtual machine typically runs its own operating system, which may be the same as or different from the operating systems executed by other virtual machines executed by computing system 502. Accordingly, multiple operating systems may potentially be run concurrently by computing system 502. Each virtual machine generally runs independently of the other virtual machines.

Communication subsystem 540 provides an interface to other computer systems and networks. Communication subsystem 540 serves as an interface for receiving data from and transmitting data to other systems from computing system 502. For example, communication subsystem 540 may enable computing system 502 to establish a communication channel to one or more client computing devices via the Internet for receiving and sending information from and to the client computing devices.

Communication subsystem 540 may support both wired and/or wireless communication protocols. For example, in certain embodiments, communication subsystem 540 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communication subsystem 540 may provide wired network connectivity (e.g., Ethernet) in addition to or instead of a wireless interface.

Communication subsystem 540 may receive and transmit data in various forms. For example, in some embodiments, communication subsystem 540 may receive input communication in the form of structured and/or unstructured data feeds, event streams, event updates, and the like. For example, communication subsystem 540 may be configured to receive (or send) data feeds in real-time from users of social media networks and/or other communication services such as Twitter® feeds, Facebook® updates, web feeds such as Rich Site Summary (RSS) feeds, and/or real-time updates from one or more third party information sources.

In certain embodiments, communication subsystem 540 may be configured to receive data in the form of continuous data streams, which may include event streams of real-time events and/or event updates, that may be continuous or unbounded in nature with no explicit end. Examples of applications that generate continuous data may include, for example, sensor data applications, network performance measuring tools (e.g. network monitoring and traffic management applications), clickstream analysis tools, and the like.

Communication subsystem 540 may also be configured to output the structured and/or unstructured data feeds, event streams, event updates, and the like to one or more databases that may be in communication with one or more streaming data source computers coupled to computing system 502.

Communication subsystem 540 may provide a communication interface 542, e.g., a WAN interface, which may provide data communication capability between the local area network (bus subsystem 570) and a larger network, such as the Internet. Conventional or other communications technologies may be used, including wired (e.g., Ethernet, IEEE 802.3 standards) and/or wireless technologies (e.g., Wi-Fi, IEEE 802.11 standards).

Computing system 502 may operate in response to requests received via communication interface 542. Further, in some embodiments, communication interface 542 may connect computing systems 502 to each other, providing scalable systems capable of managing high volumes of activity. Conventional or other techniques for managing server systems and server farms (collections of server systems that cooperate) may be used, including dynamic resource allocation and reallocation.

Computing system 502 may interact with various user-owned or user-operated devices via a wide-area network such as the Internet. An example of a user-operated device is shown in FIG. 5 as client computing system 502. Client computing system 504 may be implemented, for example, as a consumer device such as a smart phone, other mobile phone, tablet computer, wearable computing device (e.g., smart watch, eyeglasses), desktop computer, laptop computer, and so on.

For example, client computing system 504 may communicate with computing system 502 via communication interface 542. Client computing system 504 may include conventional computer components such as processing unit(s) 582, storage device 584, network interface 580, user input device 586, and user output device 588. Client computing system 504 may be a computing device implemented in a variety of form factors, such as a desktop computer, laptop computer, tablet computer, smart phone, other mobile computing device, wearable computing device, or the like.

Processing unit(s) 582 and storage device 584 may be similar to processing unit(s) 512, 514 and local storage 522, 524 described above. Suitable devices may be selected based on the demands to be placed on client computing system 504; for example, client computing system 504 may be implemented as a “thin” client with limited processing capability or as a high-powered computing device. Client computing system 504 may be provisioned with program code executable by processing unit(s) 582 to enable various interactions with computing system 502 of a message management service such as accessing messages, performing actions on messages, and other interactions described above. Some client computing systems 504 may also interact with a messaging service independently of the message management service.

Network interface 580 may provide a connection to a wide area network (e.g., the Internet) to which communication interface 540 of computing system 502 is also connected. In various embodiments, network interface 580 may include a wired interface (e.g., Ethernet) and/or a wireless interface implementing various RF data communication standards such as Wi-Fi, Bluetooth, or cellular data network standards (e.g., 3G, 4G, LTE, etc.).

User input device 586 may include any device (or devices) via which a user may provide signals to client computing system 504; client computing system 504 may interpret the signals as indicative of particular user requests or information. In various embodiments, user input device 586 may include any or all of a keyboard, touch pad, touch screen, mouse or other pointing device, scroll wheel, click wheel, dial, button, switch, keypad, microphone, and so on.

User output device 588 may include any device via which client computing system 504 may provide information to a user. For example, user output device 588 may include a display to display images generated by or delivered to client computing system 504. The display may incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). Some embodiments may include a device such as a touchscreen that function as both input and output device. In some embodiments, other user output devices 588 may be provided in addition to or instead of a display. Examples include indicator lights, speakers, tactile “display” devices, printers, and so on.

Some embodiments include electronic components, such as microprocessors, storage and memory that store computer program instructions in a computer readable storage medium. Many of the features described in this specification may be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processing unit(s) 512, 514 and 582 may provide various functionality for computing system 502 and client computing system 504, including any of the functionality described herein as being performed by a server or client, or other functionality associated with message management services.

It will be appreciated that computing system 502 and client computing system 504 are illustrative and that variations and modifications are possible. Computer systems used in connection with embodiments of the present invention may have other capabilities not specifically described here. Further, while computing system 502 and client computing system 504 are described with reference to particular blocks, it is to be understood that these blocks are defined for convenience of description and are not intended to imply a particular physical arrangement of component parts. For instance, different blocks may be but need not be located in the same facility, in the same server rack, or on the same motherboard. Further, the blocks need not correspond to physically distinct components. Blocks may be configured to perform various operations, e.g., by programming a processor or providing appropriate control circuitry, and various blocks might or might not be reconfigurable depending on how the initial configuration is obtained. Embodiments of the present invention may be realized in a variety of apparatus including electronic devices implemented using any combination of circuitry and software.

### User Interface

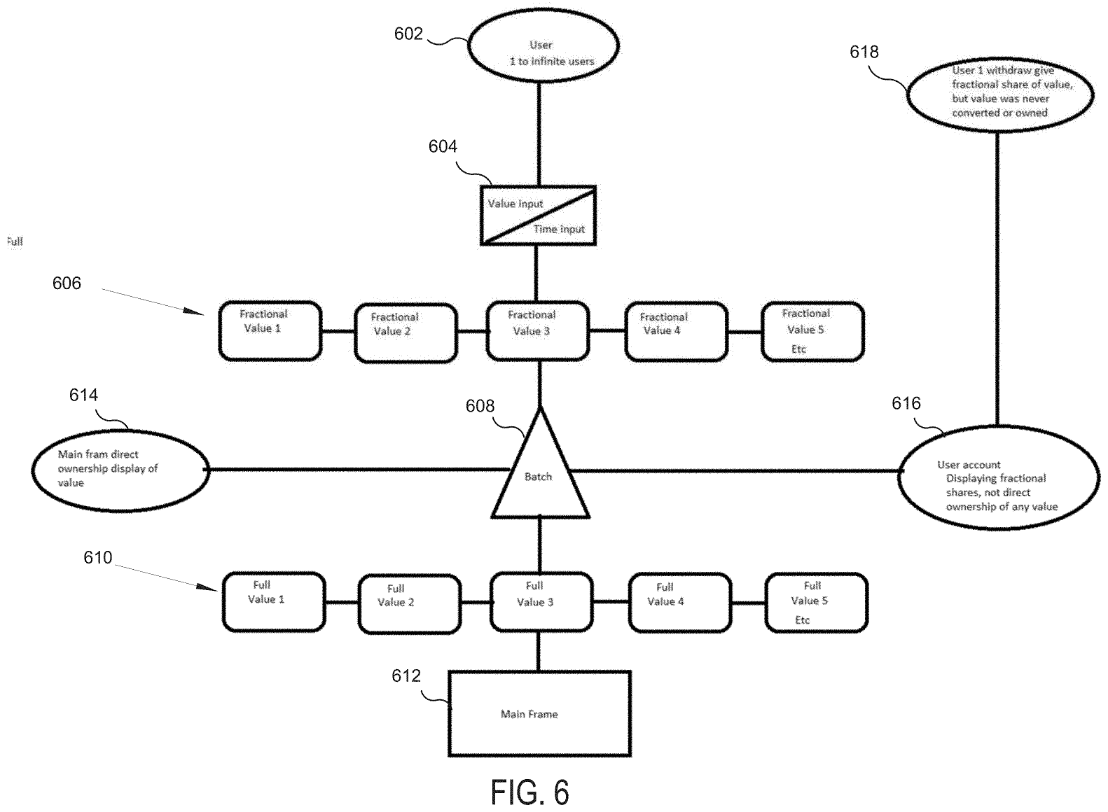

FIG. 6 is a diagram illustrating the interface with a user, according to certain embodiments. In embodiments, user/s 602 login to the system, and are able to redeem any value on the system in fractional shares. Each user input value 604 into the system, which could be the users time/effort as the value. The user is allocated a fractional value 606 (values 1-5 are shown, but there is no limit). The fractional values are batched (608), and aggregated to provide fractional ownership in one or more full value shares 610, which are controlled by a main frame computer 612, or a server or group of computers. Each user's shares are represented in fractional shares of any store of value, and are displayed as such to each user (614).

The main frame holds the actual stores of value and as new users add value to the system in either equivalent value or time value, they are awarded their fractional shares of the main frame value. The batching process occurs at regulated intervals dependent on the availability and value preference of any stored values, and represents a fractional share of the actual wallet of the main frame. The user does not actually obtain any ownership in the assets, but rather a claim of ownership to a fractional share of value, what may not actually correspond to the actual value established in the mainframe (616).

When a user withdraws their perceived value (618), the main frame allocates their allotted share, and then would transfer value back to the user in the original input method or through another store of value the user would select. This process essentially allows any value to be onboarded nearly instantaneously, and then a human component, along with degrees of artificial intelligence, dictates when the value is batched, and exchanged.

### Concierge

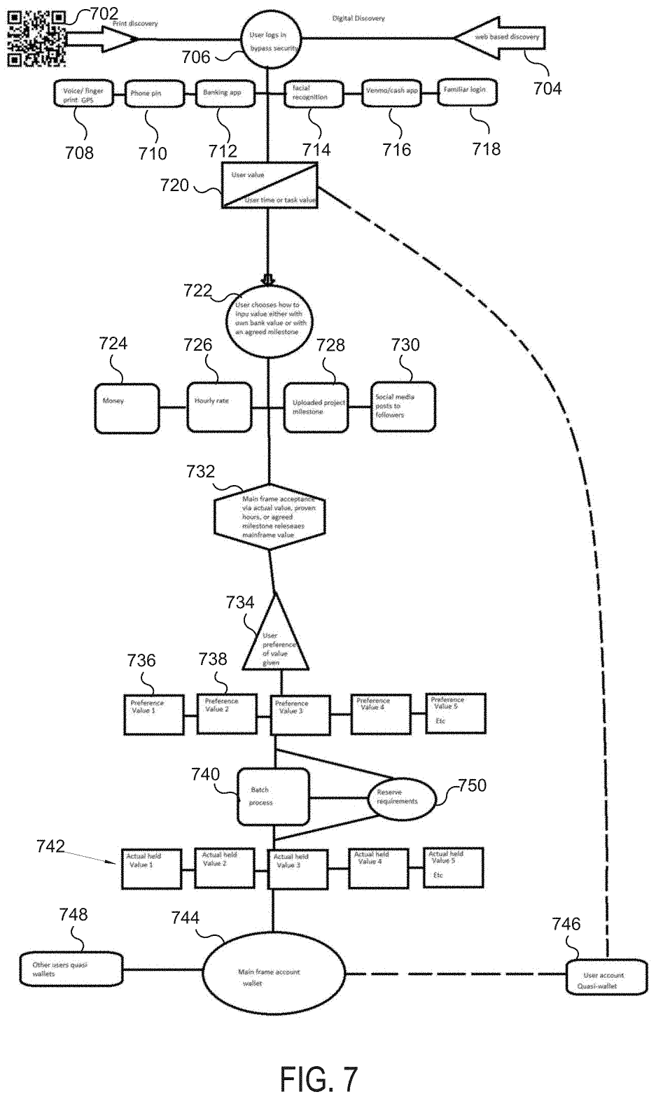

FIG. 7 is a diagram illustrating a concierge system, according to certain embodiments. In embodiments, the concierge system displays a QR code 702 via print or digital discovery 704 on the Internet. The code is scanned to a user device (e.g., phone, tablet or computer) and automatically logs in the user (706), bypassing the need to enter separate authentication information. The user can access the system using Voice/fingerprint or GPS authentication 708, a phone PIN 710, a banking app 712, facial recognition 714, a payment application 716 (e.g., Venmo®, Zelle®, PayPal® payments services) or a cash app, or any other familiar login 718. The user is then able to purchase crypto at a touch of a button, with the back side of the system handling the details and fractional allocations without delays. Thus, the user interface is simplified, having very few touch points.

The user provides a user value 720, which can be a time or task value. As discussed with respect to FIG. 6, the wallet is not owned by the user, but is owned by the mainframe, with a computational share provided back to the user, with a contractual right to the wallet that can be exchanged for value. The user chooses (722) how to input value, such as, for example, either with the users own bank value, or with an agreed milestone. The value can be represented many ways, such as, for example, money 724, an hourly rate 726, an uploaded project milestone 728, a social media post to followers 730, etc. The main frame accepts the value (732), via actual value, proven hours, agreed milestone releases or other mainframe value. This is all recorded in blocks of a blockchain, implementing smart contracts that operate automatically, but at the direction of the main frame and batching process as determined by human and artificial intelligence when certain milestones are accomplished.

This concierge system provides a social equity economy. A users or influencer can deposit their time value, task value, or posts to social media in exchange for value out of a tokenized project, so they can bill against their time or task or online posts for fractional shares and then redeem them for a selected currency at the deemed exchange rates. A user will accomplish a certain task or exchange a certain value, and the user gives the main frame a value exchange preference (734) ranging from Value 1 (736), value 2 (738) etc. The main frame then determines the quality of the commitment and then honors the User's time for a certain value. A batch process 740 occurs and then the value 742 (e.g., one of values 1-5 or more) is added to the mainframe account wallet 744, which is owned by an intermediary or sponsor company.

The user then is given their fractional represented share in a quasi wallet 746, so they do not actually own anything except fractional shares in the company, that is then converted back to the selected value. Other users have their own quasi wallets 748.

A reserve ledger (e.g., account) 750 is provided. A reserve requirement on the app holds a lesser percentage of the actual currency values so when a user wants to withdraw they are actually withdrawing against the reserve ratios—similar to how a bank would hold USD or equivalent. This allows the system to hold multiple types of value (e.g., multiple blockchain NFTs, crypto, etc.) and allows the back-end to invest in the best assets outside of that what the app users are requesting. This will create an internal economy where some users give their time and other users give their services, all with intent or goal of building the intended project they want value in.

### CONCLUSION

While the invention has been described with respect to specific embodiments, one skilled in the art will recognize that numerous modifications are possible. Embodiments of the invention may be realized using a variety of computer systems and communication technologies including but not limited to specific examples described herein.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter. The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosure.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

Embodiments of the present invention may be realized using any combination of dedicated components and/or programmable processors and/or other programmable devices. The various processes described herein may be implemented on the same processor or different processors in any combination. Where components are described as being configured to perform certain operations, such configuration may be accomplished, e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present invention may be encoded and stored on various computer readable storage media; suitable media include magnetic disk or tape, optical storage media such as compact disk (CD) or DVD (digital versatile disk), flash memory, and other non-transitory media. Computer readable media encoded with the program code may be packaged with a compatible electronic device, or the program code may be provided separately from electronic devices (e.g., via Internet download or as a separately packaged computer-readable storage medium).

Thus, although the invention has been described with respect to specific embodiments, it will be appreciated that the invention is intended to cover all modifications and equivalents within the scope of the following claims.

What is claimed is:

1. A system comprising:
a user device associated with a user and configured to provide a user code in connection with a transaction;
a reader configured to read the user code;
a first computer configured to receive the user code from the reader and generate award information related to the transaction;
a ledger computer configured to receive the user code and the award information from the first computer, and indicate a value assigned to the user;
a pool module configured to assign a fractional interest of a unit to the user corresponding to the value;
the pool module further configured to aggregate a plurality of fractional interests from a plurality of users until the fractional interests correspond to a full unit; and
a blockchain computer configured to obtain a blockchain unit in a blockchain corresponding to the full unit and assign it to the pool module.

2. The system of claim 1 wherein said blockchain unit is a cryptocurrency.

3. A reader device comprising:
a wireless reader for reading a code;
a projection element for projecting information relating to the code;
a speaker for providing audio related to the information.

4. The reader device of claim 3 wherein the wireless reader is one of a bar code reader, a QR code reader, a short range wireless reader, a near field wireless reader.

5. The reader device of claim 3 wherein the projection element is a holographic projector.

6. A method comprising:
providing a user code in connection with a transaction;
a reader configured to read the user code;
receiving the user code from the reader and generate award information related to the transaction;
receiving the user code and the award information from the first computer, and indicate a value assigned to the user;
assigning a fractional interest of a unit to the user corresponding to the value;
aggregating a plurality of fractional interests from a plurality of users until the fractional interests correspond to a full unit; and
obtaining a blockchain unit in a blockchain corresponding to the full unit and assign it to a pool.

7. The method of claim 6 further comprising:
providing a concierge service that supports a social equity economy by allowing users to input social equity as value.
